(19) United States
(12) Patent Application Publication
(10) Pub. No.: US 2008/0057920 A1
(43) Pub. Date: Mar. 6, 2008

(54) Interactive Marketing on Mobile Telephone

(75) Inventors: Tupper F. Pettit, Santa Cruz, CA (US); Jason A. Ashton, Santa Cruz, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: CommonWealth Intellectual Property Holdings, Inc., Santa Cruz, CA (US); SpeakSoft, Inc., Santa Cruz, CA (US)

(21) Appl. No.: 11/679,691

(22) Filed: Feb. 27, 2007

Related U.S. Application Data
(60) Provisional application No. 60/777,974, filed on Feb. 28, 2006.

(51) Int. Cl. H04Q 7/00; G06Q 30/00

(52) U.S. Cl. 455/414.1; 705/14

(57) ABSTRACT

A method for awarding free minutes of cellular service or other consideration to a user of a telephone willing to view or hear advertisements or receive other information includes providing information to the user and awarding the user with free cellular service minutes or other consideration in exchange for the user of the system viewing or listening to the information.

### BACKGROUND OF THE INVENTION

The present invention relates to wireless communication devices and mobile telephones.

Wireless communication devices such as mobile telephones are widely used as a replacement for, and in addition to, conventional telephone systems. In addition to providing the functionality of a conventional telephone, mobile telephones offer the advantage of portability, enabling the user to establish a wireless communication links almost anywhere.

Mobile telephones operate within regions or cells of coverage, each cell providing a geographic coverage area. A transmitter and receiver located within each cell are controlled such that the effective geographic coverage area of the cell overlaps with adjacent cells. Cells for analog mobile telephones and cells for digital telephones may not be coextensive. That is, although a given city may have complete analog cellular coverage and complete digital cellular coverage, analog and digital cell boundaries are usually different.

Currently, most wireless telephone companies charge their subscribers based upon the time that the cellular service is used, for example, based on the number of minutes the mobile telephone is placing or receiving telephone calls. Typically a customer subscribes to a service plan that allows them a specified number of minutes of use per month for a specified monthly fee, e.g., 500 minutes for $39.95 per month. Any minutes over the subscribed 500 minutes are usually charged for extra. People thus incur an extra service fee if they use the mobile telephone more than their plan allows.

### DETAILED DESCRIPTION OF THE INVENTION

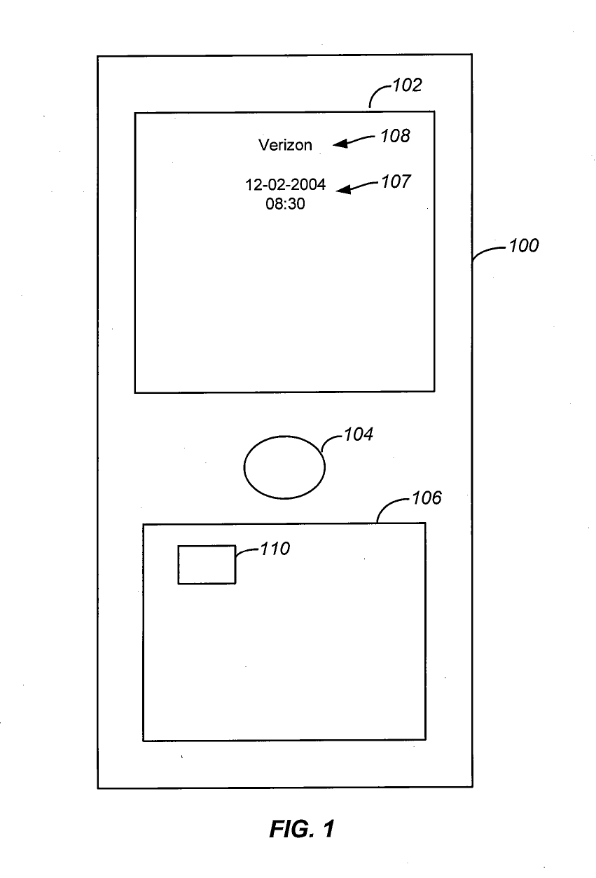

FIG. 1 illustrates a mobile telephone 100 according to one embodiment of the present invention. The mobile telephone includes a display area 102, a navigation control 104, and a keypad 106 enabling the user to enter alphanumeric information to make telephone calls, send text messages, or perform other activities. The display area 102 usually displays the time and date 107. The name of the mobile telephone company 108 may also be displayed on the display area. The navigation control is used to scroll or navigate through various programs and applications provided by the telephone. The keypad 106 is used to input telephone numbers to call or data. A send button 110 is pressed to make the call once the telephone number has been entered. As used herein, a mobile telephone is any portable device that can be used to make or receive telephone calls, e.g., a personal digital assistant is considered a mobile telephone if it can make or receive telephone calls.

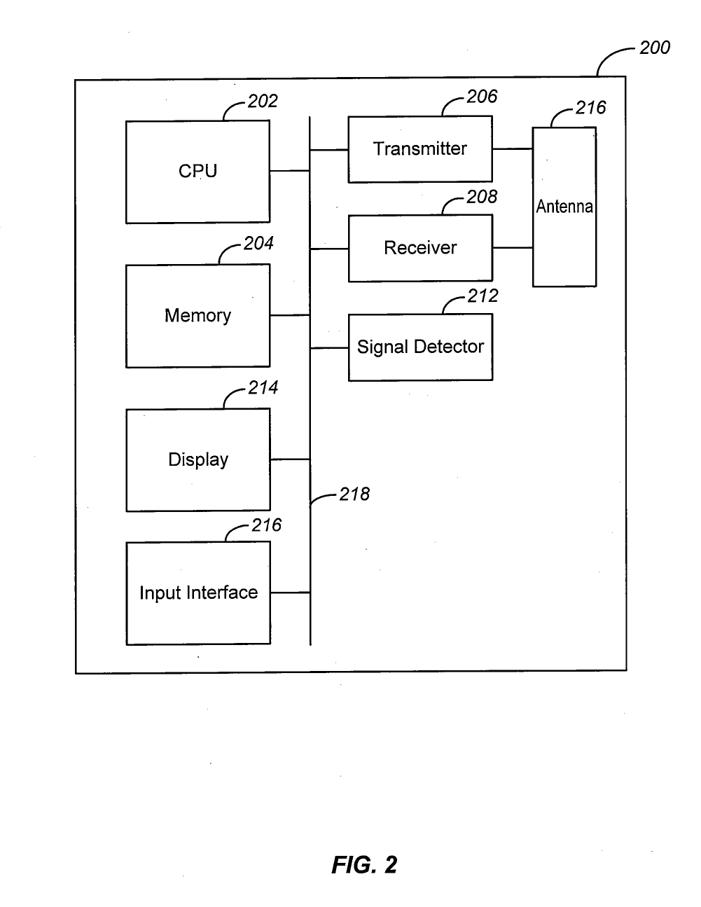

FIG. 2 illustrates a mobile telephone 200 according to one embodiment of the present invention. The telephone 200 includes a processor (or CPU) 202 which controls operation of the telephone. A memory 204, which may include both read-only memory (ROM) and random access memory (RAM), provides instructions and data for use by the CPU 202. A portion of the memory 104 may also include non-volatile random access memory (NVRAM).

The telephone 200 includes a transmitter 206 and a receiver 208 to allow transmission and reception of data, such as audio communications, between the telephone 200 and a remote location, such as a cell site controller or BTS. The transmitter 206 and receiver 208 may be provided as a single component, i.e., a transceiver. An antenna 210 is used to receive and send data.

The telephone 200 also includes a signal detector 212 used to detect and quantify the level of signals received by the receiver 208. The signal detector 208 detects such signals as total energy, pilot energy per pseudonoise (PN) chips, power spectral density, and other signals, as is known in the art.

The telephone 200 includes a display device 214 that displays information, such as, characters, numbers, images, and the like. An input interface or key pads 216 is used to input information and includes number/key pads, a navigation control, and the like. The input interface is used to input telephone numbers to call another person, send data to a remote communication device, configure the wireless communication device, and the like.

The various components of the telephone 200, including those mentioned above, are coupled together by a bus system 218 which may include a power bus, a control signal bus, and a status signal bus in addition to a data bus. For simplicity the various buses are illustrated in FIG. 2 as the bus system 218.

According to the present embodiment, a subscriber or user of the mobile telephone is provided with an option to obtain a “free” minutes of use of the cellular system by agreeing to listen to or view certain information. The information may be commercial information, public announcements, political advertisements, or any other type of information. The user may agree to such an arrangement in advance, e.g. when the user enters into a service plan with the cellular provider. Alternatively, the user may enter into the arrangement “on the fly” when he or she realizes that he or she has few or no minutes of use available. As used herein, the free minutes refers to telephone use time awarded to a user for participating in an event, e.g., listening to or viewing certain information.

In one embodiment, the user uses the navigation control 104 to select and participate in the free-minutes-award program. Thereafter, the user listens to or views certain information, e.g., a commercial. The commercial lasts for a predetermined period, e.g., 30 seconds. In response to these events, the user is granted a predetermined number of minutes of use of the cellular system, e.g., 2 minutes. If the user exceeds the awarded free minutes, the call may end or the user may pay for the extra minutes as is conventional for use in excess of the user's calling plan. Typically the commercial will originate from an advertiser and be provided to the cellular system for transmission to the cellular user under the circumstances described herein.

Alternatively, the user may sign up for an award program, so that whenever the user enters a telephone number, or makes a call to a certain number, e.g. 411 for directory assistance or an 800 number for toll free calling, and presses the send button 110, a commercial is played for a given period of time. The user then receives the free minutes of use. The telephone number entered is saved in the memory device 204 while the commercial is being played, so that the user does not need to enter the telephone number again after the commercial. Once the commercial has finished, the telephone call is made using the telephone number stored in the memory device.

In one implementation, the user is required to use the free talking time relatively promptly, not being allowed to save it for use after that day or billing period, or other interval. In another implementation, the free minutes can be used later.

To assure that the user has received the information, in one implementation, a user is required to correctly perform a specific act after listening to or viewing the information. For example, in one implementation, the user is required to press a given button within a short period of time, e.g., 2 seconds, after the commercial has finished. If the user presses the button correctly within the time, the user is awarded the free minutes. If not, no free minutes are awarded. In other implementations, the user may be required to perform other tasks. For example, the user may be required to press a specific number, e.g., 2, that is displayed or announced during the commercial. In yet another implementation, the user may be asked a simple question based on the commercial.

In another embodiment, the information being played on the mobile telephone relates to interactive marketing. When the user enters a telephone number and presses the send button 110, the user is asked or shown a brief marketing question. For example, “Are you interested in purchasing two movie tickets for $10?” “If so, press “1” or say “YES.”” “If not, press “2” or say “NO.”” If the user presses “1” or says “YES,” the user is connected to a telephone number other than that which the user had entered to complete the transaction. If user presses “2” or says “NO,” the user is connected to the telephone number the user had entered. For this purpose, the telephone number the user had entered is stored in the memory device 204, so that the user does not need to reenter the telephone number.

In one implementation of this system, after pressing “1” or saying “YES,” the user is provided with an option to complete the call first. After the call, the user is asked or shown further options to complete the transaction (or directed to another telephone number). If desired, the user information needed to complete the transaction, e.g., the name and credit card information, is stored in the memory device, so that the user may press a single button to send the information to the party on the other line. For privacy, the information may be stored in the memory device in encrypted form, and transmitted in encrypted form for security. In this case, prior to sending the user information, the user is asked to enter a password as additional security. If the correct password is not entered, the user information is not sent.

Described next are enhancements to the approach discussed above. Generally, advertising on mobile devices is an infant market currently utilizing existing technologies, such as recordings played during telephone calls or images and banners displayed on internet browsers. These advertisements are essentially static, small and unreadable and not usually targeted towards the mobile user. In our system we match different embodiments of advertisements to spoken utterances of the handset user, preferably using voice recognition and/or displaying a similar, different or associated advertisement, a special offer, or a coupon etc. that may differ from the audio being heard or shown on the handset.

These various implementations of advertising include audio received on the handset, as well as numerous forms of multi-modal advertising that allow the caller to receive advertisements displayed directly on the handset in various formats without interrupting a call in process. These embodiments of advertising methods offered by the invention include, but are not limited to, audio, static and animated images, streaming video, SMS (text messages), MMS (multi-media messages that can include images, video, audio, and text), and WAP (internet pages that can display any data available to web services), as well as other advertising formats.

In one implementation the caller can accept an advertisement offer during a call using voice recognition or navigation keys on the handset and be connected with the advertiser for fulfillment without disrupting the original call. Alternatively the caller can receive advertisements that remain on the handset and can be used as coupons or responded to at will by the handset user. The advertisements can contain specific special offers, deals, instant rebate certificates, coupons, or offer brand recognition and/or product and service awareness. An advertising manager can arrange to match specific advertising to specific spoken utterances.

In another embodiment of the invention, a specific spoken utterance can have multiple types of advertising matched against it. For example, if the spoken utterance is “United Airlines” the invention select a United Airlines advertisement, or it could select an advertisement from a competitor of United Airlines, or general advertisements related to travel. The caller uttering “United Airlines” causes the system to send an ad to the handset. In other words, an ad can be sent to the display on the handset that does not match the audio being heard. The caller continues speak or listen to the original call but the handset display can be showing an ad, a special offer, a coupon for product or service and the like, that may be closely associated with the conversation, keywords and/or phrases. The caller in some cases must enter a key stroke or utter a response to redeem and preserve the free minutes of service, the special offer, the coupon, the free 411 service, etc. for a month and the like with out disrupting the original call.

In another embodiment of the invention, rule based analysis is executed to select from multiple potential matched advertisements to determine the highest value proposition for the caller and for the advertiser based on known or discovered data concerning the caller and known or discovered data from the potential matching advertisements and dynamic data provided by advertisers. This best matching system is intended to offer advertisements that the caller is more likely to respond to, and also offer advertisers the highest return on their advertising costs.

The engine's algorithms use variable weightings assigned to the data to help the system select advertisements that provide the desired value to each advertiser, user of the system, channel partners etc. This increases the value of advertising by increasing the likelihood that callers who receive an advertisement will respond to it.

The known or discovered data concerning the caller includes, but is not limited to, caller id (to identify the caller), location based data (where they are calling from), a collection of spoken utterances matched using voice recognition, user responses to inquiries from the system, spoken or saved user preferences and interests, previously archived data about the caller such as transactions processed through the system and prior accepted and rejected advertisement offers and other potential discoverable caller data. Known or discovered data concerning the advertiser or advertisements includes, but is not limited to, inventory, supply/demand analysis, advertisement weightings which can be increased by amount spent, ad exposure analysis, etc.

If multiple matching advertisements are determined to have differing value to the caller and the advertiser, the system will offer the most valuable match to the caller. If the multiple matching advertisements are determined to be of equal value to the caller based on current data, the invention will select an advertisement based on maximizing return based on other criteria, e.g. cost or fees.

For example, if the ad displayed to the user involves United Airlines, the system having data about the call (i.e. the call belongs to the United Mileage Plus program) has created an itinerary from San Francisco, Calif. to Seattle Wash. the system navigates through various data bases and determine that the caller may not have a affinity program with American Airlines. Therefore, offering 5000 additional air miles to this caller is of very little value. The system using PIM or other means of determining inventory levels of the American Airline's flight from San Francisco to Seattle offers a free friends fly free ticket for the same price as United Airlines (e.g. if the caller signs up for American Airlines mileage program).

The caller can be redirected to American Airlines by using perishable inventory i.e. low occupancy at a hotel, in which case the system rather than offer free minutes may offer a free night if the caller pays for two nights. The system can do computations to determine that a free night combined with two paid night's is equal to the net profit for the sponsor. In effect, the system analyzes the caller responses and redirects them in some cases to other locations then the caller's first intention of obtaining free minutes by other offers of potential value based upon the information available.

In other embodiments, a computer system can monitor dialog during the call itself to present ads based on the conversation of the call. The caller would approve and accept free offers, advertisement, coupons and the like based on conversations taking place in real time.

The above description has been provided merely to illustrate the present invention. Accordingly, only selected embodiments of the present invention have been described. The scope of the invention should not be narrowed based on the specific embodiments provided above. For example, the present invention may be implemented with a conventional wired telephone.

What is claimed is:

1. A method for awarding talking minutes to a user of a telephone, comprising:
providing information to the user; and
awarding the user with a given amount of talking minutes as a consideration for viewing or listening to the information.
